(19) United States
(12) Patent Application Publication
(10) Pub. No.: US 2005/0121429 A1
(43) Pub. Date: Jun. 9, 2005

(54) Apparatus and method for inspecting and repairing a circuit defect

(75) Inventors: Kuo-Ting Liao, Taipei City (TW); Kuo-Kuei Lee, Taipei City (TW); Chun Chien Chu, Banciao City (TW)

Correspondence Address: BACON & THOMAS, PLLC, 625 SLATERS LANE, FOURTH FLOOR, ALEXANDRIA, VA, 22314, US

(73) Assignee: Quanta Display Inc., Kuei Shan Hsiang (TW)

(21) Appl. No.: 10/855,331

(22) Filed: May 28, 2004

(30) Foreign Application Priority Data
Dec. 3, 2003 (TW) 092134268

(51) Int. Cl. B23K 26/10

(52) U.S. Cl. 219/121.78; 219/121.83

(57) ABSTRACT

An apparatus for inspecting and repairing a circuit defect is disclosed, which has a base; a substrate-supporting platform mounted on the base; a contact inspection module having at least one contact probe and a first driving-system that drives at least one contact probe to contact the circuits formed on the glass substrate and thereby inspect a circuit defect; a non-contact inspection module having at least one non-contact sensor and a second driving-system that drives at least one non-contact sensor to inspect the circuit defect in a non-contact manner; and a laser repair module having a laser head and a third driving-system that drives the laser head to go to the circuit defect and repair the circuit defect. A method for inspecting and repairing a circuit defect is also disclosed therewith.

### BACKGROUND OF THE INVENTION

1. Field of the Invention

The present invention relates to an apparatus and method for inspecting and repairing circuit defects of a liquid crystal display device and, more particularly, to an apparatus that concurrently has functions of inspecting and repairing circuit defects of a liquid crystal display device.

2. Description of Related Art

With reference to FIGS. 1 and 2, a plurality of metal lines having a matrix pattern is formed on a glass substrate 10 after the array process of the manufacturing procedure of a liquid crystal display device. The metal lines include the data lines (source lines) 11 and the scan lines 12. However, some circuit defects like the short defect 30 or the open defect 20 are very frequently formed due to imperfections of process. Generally, an open/short inspection machine is used to inspect for those kinds of defects. The inspection method of the open/short inspection machine commonly includes a non-contact type inspection and a contact type inspection. The non-contact type inspection usually uses two non-contact sensors 13, 14, which may be the electrostatic capacitory coupling type. The non-contact sensor 14 serves as a signal output end, and the sensor 13 serves as a signal-receiving end. During operation, both the sensors 13, 14 are extremely close to the glass substrate 10, and the distance between the sensors 13, 14 and the glass substrate 10 is about 100 μm only. Take the inspection of the source lines 11 for example, both the sensors 13, 14 are moved synchronously to find the line position of the open defect 20 first. After the line position of the open defect 20 is determined, the sensor 14 stops moving and the sensor 13 keeps moving along the line position and towards the stationary sensor 14 until the signal received by the sensor 13 has changed. Thus, the position of the open defect 20 can be found, as shown in FIG. 1. On the other hand, a pair of contact probes 50 can be used to touch the contact pad 40 after the line position of the short defect 30 has been found, and then the non-contact sensor 13 is used to find the position of the short defect 30, as shown in FIG. 2.

In the conventional procedure, the defective products picked out by the open/short inspection machine have to be repaired by a laser repair machine. The laser repair machine can mend the short defects and thus raise the yield of products. However, the inspection information obtained by the open/short inspection machine, such as the coordinates and the images of the circuit defects are firstly stored in a memory of the open/short inspection machine, and then transmitted to the laser repair machine through the Internet or a disc. As for the glass substrates that need to be repaired, they are transported independently to the laser repair machine by an additional conveyance. Certainly, additional transportation means, such as robots are used to transport the glass substrates between the open/short inspection machine and the conveyance and also between the conveyance and the laser repair machine. After the glass substrate is put in the laser repair machine, it has to be aligned again, and then be repaired according to the information transmitted from the open/short inspection machine.

In such a conventional procedure, the open/short inspection machine and the laser repair machine are two distinctly separate machines, so the glass substrates have to be transported between the machines which are time-consuming. Besides, the process line is too long, and merely leads to increases in rework risk of defective products and occupied space of cleaning room. In addition to that, the glass substrate has to be aligned again in both machines, which not only increases the operation time, but also lowers the whole precision of alignment due to different coordinate systems. Thus, the use of two separate machines does not benefit the trend of an increasingly narrow line width and the automation of defect inspection and repair.

With reference to FIG. 3, U.S. Pat. No. 5,164,565 disclosed a laser-based system for material deposition and removal. During the operation, the substrate 10 is held by an X-Y translation stage 60, which is driven to move the substrate 10 relatively to the stationary laser head 70. The design above-mentioned is frequently used in the inspection machine, too. However, as the substrates have become bigger and bigger, that kind of design will occupy more and more space in both machines. As a result, the cost in facility will increase, and the precision of the whole procedure will fall. The preferred design is that the laser head 70 is moved relatively to the stationary substrate. Similarly, as for the circuit defect inspection machine, it is preferred to fix the glass substrate and to move the contact probe 50 and the non-contact sensors 13, 14.

In these preferred design of the inspecting machines or the laser repair machine illustrated above, many similar or common alignment and transportation elements can be found in either the individual inspection machine or in the individual laser repair machine. The difference found in these two preferred machines can be only the additional inspection module or the additional laser repair module. Therefore, it is feasible to provide an apparatus having both inspection and repair functions and desirable to provide an apparatus for inspecting and repairing circuit defects to save the occupied space of the clean room or to mitigate and/or obviate the aforementioned problems.

### SUMMARY OF THE INVENTION

The object of the present invention is to provide an apparatus for inspecting and repairing a circuit defect so that the space occupied by the inspection and repair machines is reduced, and the inspection and repair of circuit defects can be carried out precisely and quickly.

Another object of the present invention is to provide a method for inspecting and repairing a circuit defect so that the time for production or manufacturing can be effectively saved, and the yield can be significantly increased.

To achieve the object, the apparatus for inspecting and repairing a circuit defect of the present invention includes a base; a substrate-supporting platform mounted on the base for supporting a glass substrate; a contact inspection module having at least one contact probe and a first driving-system, wherein the first driving-system drives at least one contact probe to contact the circuits formed on the glass substrate and thereby to inspect a circuit defect; a non-contact inspection module having at least one non-contact sensor and a second driving-system, wherein the second driving-system drives at least one non-contact sensor to inspect the circuit defect in a non-contact manner, and the non-contact inspection module cooperates with the contact inspection module for determining a position of the circuit defect; and a laser repair module having a laser head and a third driving-system, wherein the third driving-system drives the laser head to go to the position of the circuit defect and to repair the circuit defect.

To achieve the object, the method for inspecting and repairing a circuit defect of the present invention includes the steps of providing an apparatus having a substrate-supporting platform, a contact inspection module having at least one contact probe and a first driving-system that drives at least one contact probe, a non-contact inspection module having at least one non-contact sensor and a second driving-system that drives at least one non-contact sensor, and a laser repair module having a laser head and a third driving-system that drives the laser head; putting a glass substrate that waits for inspection on the substrate-supporting platform; inspecting the circuits on the glass substrate and determining the position of a circuit defect by moving at least one contact probe and at least one non-contact sensor; moving the laser head to the circuit defect and repairing the circuit defect; and moving the inspected and repaired glass substrate out of the substrate-supporting platform.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view showing how the non-contact sensors inspect the open defect in the prior art;

FIG. 2 is a schematic view showing how the contact probe that cooperates with the non-contact sensor inspects the short defect in the prior art;

FIG. 3 is a perspective view of the laser repair apparatus of prior art;

FIG. 4 is a perspective view of the apparatus for inspecting and repairing a circuit defect of the present invention;

FIG. 5 is an enlarged perspective view of the contact inspection module of the present invention;

FIG. 6 is an enlarged perspective view of the first vertical driving-unit of the contact inspection module of the present invention;

FIG. 7 is an enlarged perspective view of the front-and-back driving-unit of the contact inspection module of the present invention;

FIG. 8 is a perspective view of the non-contact inspection module of the present invention;

FIG. 9 is an enlarged perspective view of the second vertical driving-unit of the non-contact inspection module of the present invention;

FIG. 10 is a perspective view of the laser repair module of the present invention;

FIG. 11 is a perspective view showing how the apparatus of the present invention inspects and repairs the circuit defect according to step (1);

FIG. 12 is a perspective view showing how the apparatus of the present invention inspects and repairs the circuit defect according to step (2);

FIG. 13 is a perspective view showing how the apparatus of the present invention inspects and repairs the circuit defect according to step (3); and

FIG. 14 is a perspective view showing how the apparatus of the present invention inspects and repairs the circuit defect according to step (4).

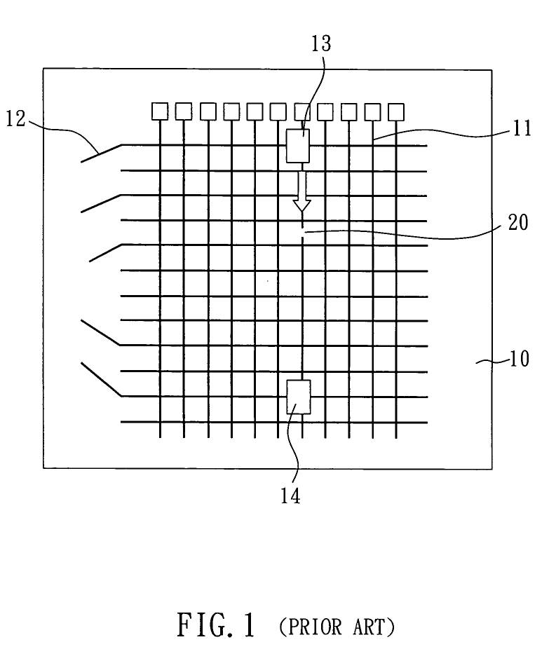

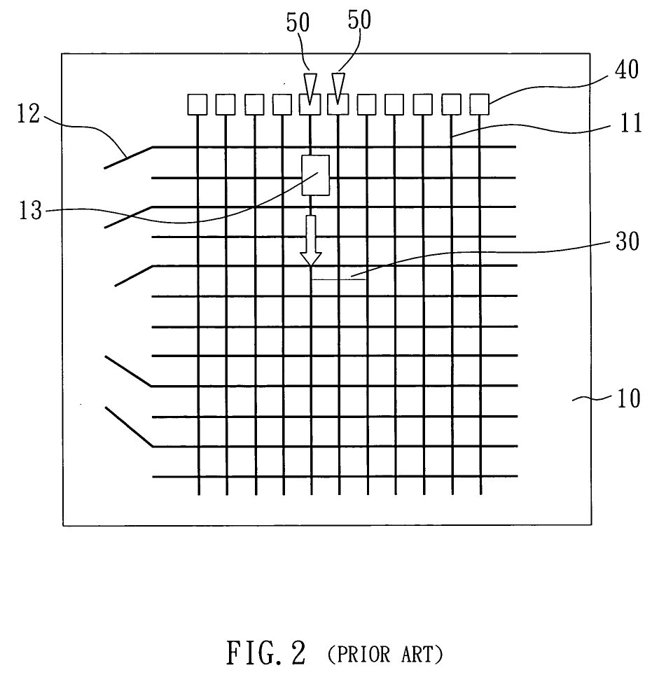

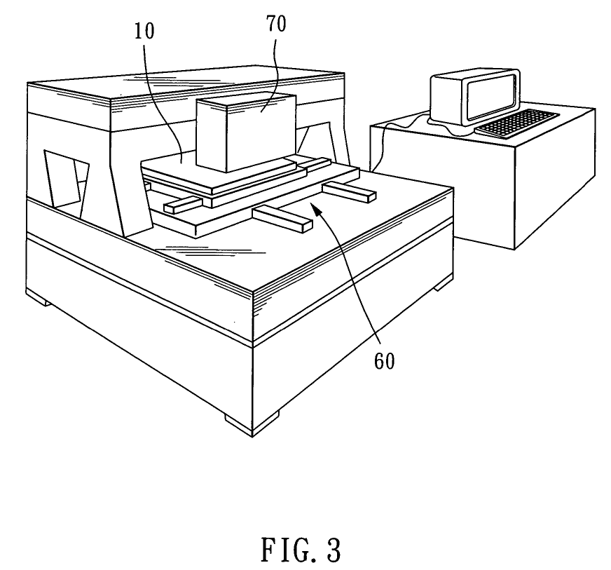

### DETAILED DESCRIPTION OF THE PREFERRED EMBODIMENT

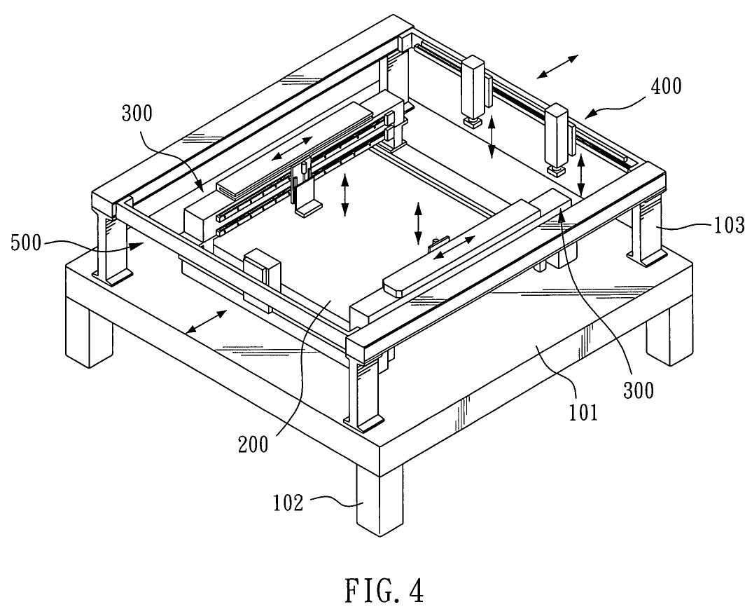

With reference to FIG. 4, there is shown a perspective view of the apparatus for inspecting and repairing a circuit defect of the present invention. The apparatus has a base 101, a substrate-supporting platform 200, a contact inspection module 300, a non-contact inspection module 400, and a laser repair module 500. Moreover, the base 101 and stands 102 serve as a foundation of the whole apparatus for supporting all the components of the apparatus. The motor supporter 103 is further utilized to support and raise the motors. The substrate-supporting platform 200 substantially resembles a rectangular plate and serves to support and fix a glass substrate. The substrate-supporting platform 200 is usually made of transparent materials, such as glass or acrylate. Moreover, the transparent substrate-supporting platform 200 can improve the contrast of images by mounting a lighting module (not shown in the figure) below the transparent substrate-supporting platform 200 if higher contrast of images is needed.

With reference to FIG. 4, there are two contact inspection modules 300 that are disposed symmetrically in the present embodiment. Next, with reference to FIG. 6, a contact probe 305 is mounted on an inspection head 305a for contacting the circuits on a glass substrate and determining the position of a circuit defect. The contact probe 305 and the inspection head 305a are driven by a first vertical driving-unit 301 so that they can be moved up and down. The first vertical driving-unit 301 is composed of a first bottom plate 301a, a linear guide way 301b, a servo rotary motor 301c, a ball screw 301d, a second bottom plate 301e that connects the linear guide way 301b through a linear slider (not shown in the figure), and a connecting plate 301f that connects the second bottom plate 301e and the inspection head 305a. Hence, through the drive of the servo rotary motor 301c, the contact probe 305 can be moved in a vertical direction relative to the glass substrate.

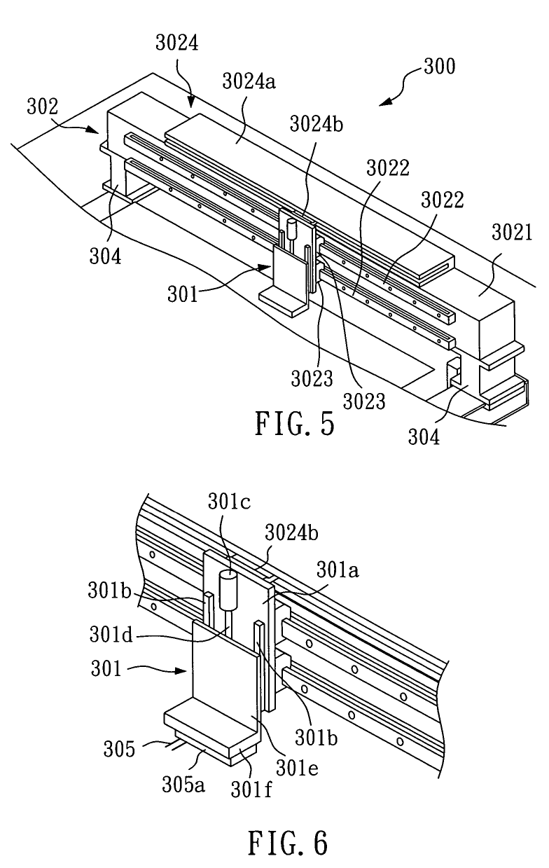

In addition to the vertical movement relative to the glass substrate, it is also necessary for the contact probe 305 to be moved in a horizontal direction relative to the glass substrate. Therefore, a first horizontal driving-unit 302 is mounted, as shown in FIG. 5. The first horizontal driving-unit 302 is composed of a supporting crossbeam 3021, two linear guide ways 3022, two linear sliders 3023, and a motor driving unit 3024. The linear motor driving unit 3024 is further composed of a motor main body 3024a, a mover 3024b, and a corresponding driving circuit (not shown in the figure). Furthermore, the motor main body 3024a has a linear slider (not shown in the figure), a position sensor (not shown in the figure), and a stator (not shown in the figure). Generally, the linear motor is classified as the linear stepping motor and the linear servo motor. The linear stepping motor has a small driving force, but it can carry out the alignment by an open-loop control and has simple structure. As for the linear servo motor, it is mainly composed of a stator that is arranged in a straight line and made of a permanent magnet, a position sensor such as an optics meter, a guide set having a linear guide way and a linear slider, a driving-unit, and a mover constructed of a steel sheet encompassing a coil. The mover connects with the linear guide way and the linear slider, and can move relative to the stator. The driving-unit inputs the driving signals, such as a voltage or a current to the mover through the coil in the mover, and thereby drives the mover to move by an action force produced by the magnetic field between the mover and the stator. Accompanying the feedback signals from the position sensor, the driving voltage or current can be adjusted to form a close-loop control system.

From the above-mentioned, the mover 3024b can be driven by the drive circuit and thereby be moved relative to the motor main body 3024a. Simultaneously, the mover 3024b connects the first bottom plate 301a of the first vertical driving-unit 301, so the first vertical driving-unit 301 can be driven by the first horizontal driving-unit 302. Consequently, the contact probe 305 can be moved in a horizontal direction relative to the glass substrate.

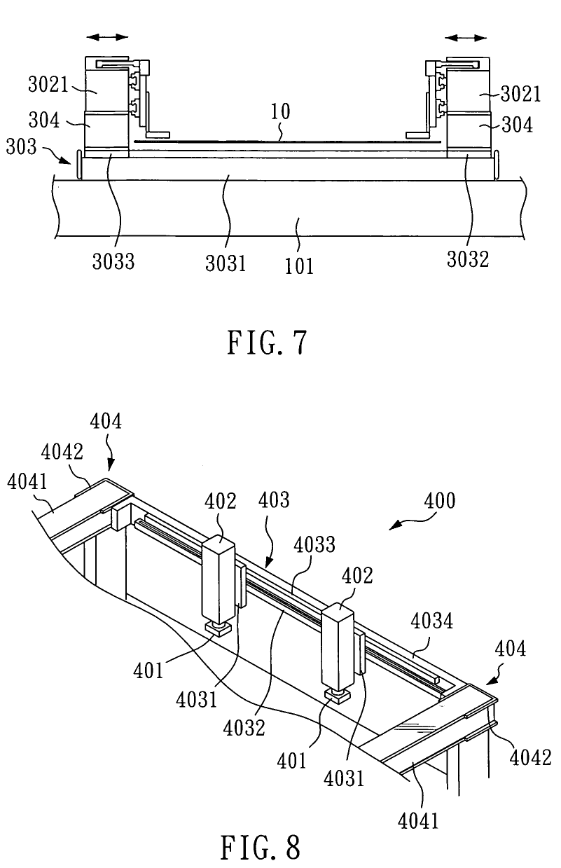

With reference to FIGS. 6 and 7, the contact probe 305 can be moved forward and backward relative to the glass substrate by a linear motor driving unit 303. The linear motor driving unit 303 is disposed symmetrically at the periphery of the substrate-supporting platform 200, wherein the symmetrical center is approximately the central line of the glass substrate. The linear motor 303 is composed of a motor main body 3031, a mover 3032 and its corresponding driving circuit (not shown in the figure), and a mover 3033 and its corresponding driving circuit (not shown in the figure). Like the motor main body 3024a, the motor main body 3031 also has a guide set (not shown in the figure), a position sensor (not shown in the figure), and a stator (not shown in the figure). The difference between the linear motor driving unit 303 and the linear motor driving-unit 3024 is that the motor main body 3031 of the linear motor driving unit 303 connects two movers, i.e. the mover 3032 and the mover 3033, as well as their corresponding driving circuits (not shown in the figure). The mover 3032 and the mover 3033 can be driven independently by their corresponding driving circuits, which is the so-called single axis and double movers technique. Compared with the conventional linear driving-unit that uses a ball screw cooperating with a rotary motor, the linear motor driving unit 303 that applies the single axis and double movers technique can greatly reduce the space occupied.

The linear motor driving unit 303 connects the first horizontal driving-unit 302 through connecting supporters 304. The connecting supporters 304 connect the movers 3032 and 3033 of the linear motor driving unit 303 with the supporting crossbeam 3021 of the first horizontal driving-unit 302 so that the linear motor driving unit 303 can drive the first horizontal driving-unit 302 to move forward and backward. In brief, the contact probe 305 can be driven by the first vertical driving-unit 301, the first horizontal driving-unit 302, and the linear motor driving unit 303 respectively and thereby move in vertical, horizontal, forward and backward directions relative to the glass substrate. Therefore, the contact probe 305 can keep good contact with the circuits on the glass substrate and achieve precise inspection no matter how the circuits are designed.

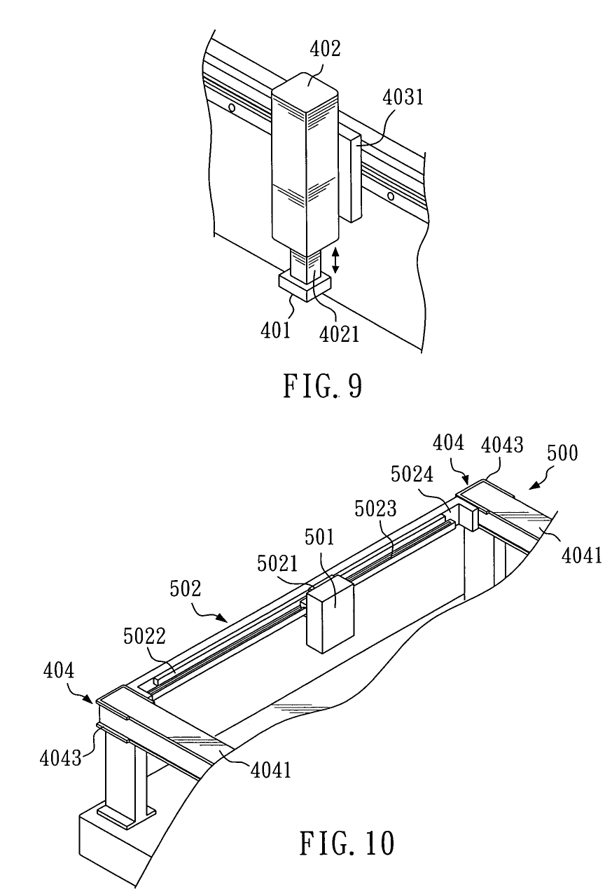

With reference to FIGS. 8 and 9, the sensor 401 in an electrostatic capacitory coupling type is driven by a shaft 4021 of an actuator 402 so that it can approach or leave the glass substrate. The actuator 402 connects the mover 4031 of the linear motor driving-unit 403. Similarly, the linear driving-unit 403 applies the single axis and double movers technique, so it has two movers that connect respectively with their corresponding actuators. The linear motor driving-unit 403 has a stator 4033, a linear guide way 4032, a linear slider (not shown in the figure), and a pedestal 4034, and can drive the sensor 401 to move horizontally.

The linear motor driving-unit 403 connects with another linear motor driving-unit 404, which also applies the single axis and double movers technique. The linear motor driving-unit 404 has a motor main body 4041, mover 4042 (as shown in FIG. 8) and mover 4043 (as shown in FIG. 10), and a pair of driving circuits (not shown in the figures) corresponding respectively to the movers 4042, 4043. Moreover, the motor main body 4041 is composed of a guide set (not shown in the figures), a position sensor (not shown in the figures), and a stator (not shown in the figures). The pedestal 4034 of the linear motor driving-unit 403 connects the movers 4042 of the linear motor driving-unit 404 so that the linear motor driving-unit 404 can drive the linear motor driving-unit 403 to move the sensor 401.

After the coordinate of the circuit defect is found through the non-contact sensor optionally combined with the contact probe, the laser can repair the circuit defect. For example, if the circuit defect is a short defect, the laser can repair it by cutting off the defect that causes the short.

With reference to FIG. 10, a laser head 501 has a laser-producing element that produces a laser with power for cutting off the metal defect, which causes the short. Also, the laser head 501 further has a microptics magnification element (not shown in the figure) for providing an image of the cutting operation. Similarly, the laser head needs a driving-unit that drives it to move to the circuit defect. In the preferred embodiment, the laser head 501 connects with a mover 5021 of a linear motor driving-unit 502. The linear motor driving-unit 502 has a stator 5022, a linear guide way 5023, a linear slider, and a bottom pedestal 5024, and can drive the laser head 501 to move horizontally. In addition, if only a single laser head 501 is used, the linear motor driving unit 502 illustrated above can be replaced by conventional driving system composed by motor and ball screw.

The linear motor driving-unit 502 also connects with the linear motor driving-unit 404 so that the laser head 501 can be driven to move forward and backward.

Moreover, the linear motor driving-unit 404 connects with the linear motor driving-unit 502 through the mover 4043 as well as the linear motor driving-unit 403 through the mover 4042 so that the single motor main body 4041 can drive the sensor 401 and the laser head 501 independently to move relative to the glass substrate. Compared with the conventional rotary motor using a ball screw, the quantity of the transmission elements and the required space of the apparatus of the present invention are substantially reduced.

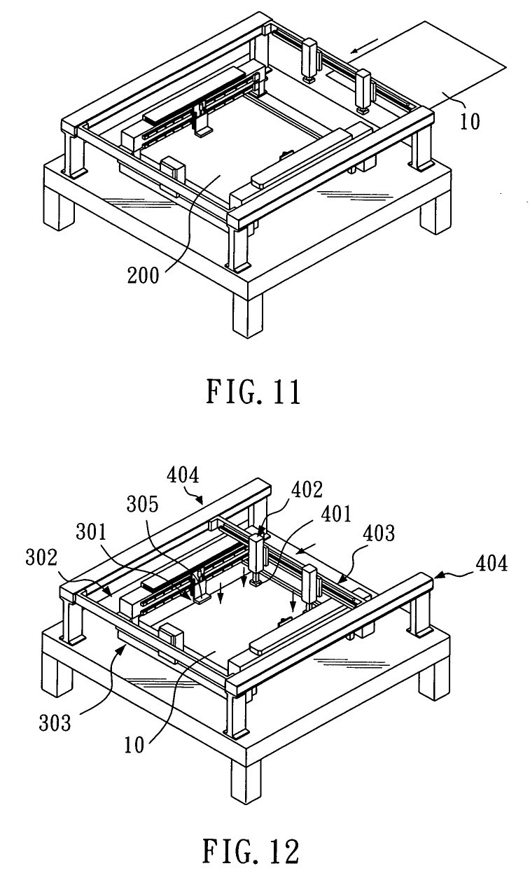

Afterwards, taking the example of a short defect, the method for inspecting and repairing a circuit defect of the present invention will be described below with reference to FIGS. 11 to 14.

(1) With reference to FIG. 11, the glass substrate 10 that waits for inspection is firstly loaded into the apparatus of the present invention by, e.g. a robot, and then fixed on the substrate-supporting platform 200.

(2) With reference to FIG. 12, the contact probe 305 can be driven by the first vertical driving unit 301, the first horizontal driving unit 302, and the linear motor driving unit 303, and thereby contact the circuits on the glass substrate 10 correctly. Also, the sensor 401 can be driven by the actuator 402, the linear motor driving unit 403, and the linear motor driving unit 404 to move close to the glass substrate 10. Hence, the sensor 401 can inspect the circuits and determine the position! of the short defect.

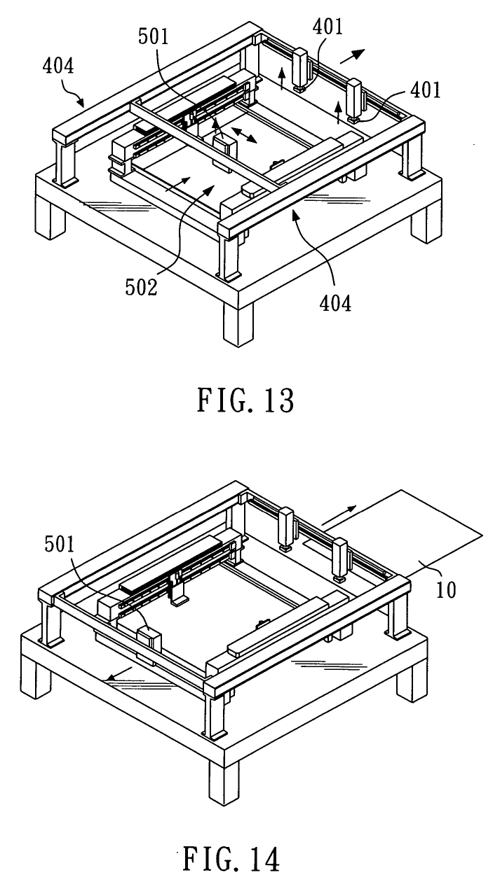

(3) With reference to FIG. 13, after the sensor 401 and the contact probe 305 have returned to their original positions, the laser head 501 is driven to the short defect by the linear motor driving-unit 502 and the linear motor driving-unit 404. Subsequently, the laser head 501 cuts off the short defect and remedies the abnormal area into a normal area.

(4) With reference to FIG. 14, after the circuit defect has been repaired, the laser head 501 returns to its original position, and then the glass substrate is unloaded from the apparatus of the present invention by, e.g. a robot. Finally, the apparatus returns to its original status and waits for the next substrate that needs inspection.

From the above-mentioned description of the apparatus and method of the present invention, it is obvious that the present invention has the following advantages as being compared with the prior arts:

(1). The apparatus of the present invention has both the functions of inspection and repair, thus the quantity of processing steps and labor hours can be greatly reduced.

(2) It is unnecessary to unload and reload the glass substrate between the inspection and the repair machines, so processing accidents will be decreased and product yield can be raised.

(3) The inspection and repair machines are integrated into a single entity, so the quantity of the transportation and driving-units thereof is greatly reduced. As a result, the cost of the apparatus of the present invention is substantially reduced. Moreover, the apparatus of the present invention is very suitable for the standard production line.

Although the present invention has been explained in relation to its preferred embodiment, it is to be understood that many other possible modifications and variations can be made without departing from the spirit and scope of the invention as hereinafter claimed.

1. An apparatus for inspecting and repairing a circuit defect, comprising:
a base;
a substrate-supporting platform mounted on the base for supporting a glass substrate;
a contact inspection module having at least one contact probe and a first driving-system, wherein the first driving-system drives at least one contact probe to contact the circuits formed on the glass substrate and thereby to inspect a circuit defect;
a non-contact inspection module having at least one non-contact sensor and a second driving-system, wherein the second driving-system drives at least one non-contact sensor to inspect the circuit defect in a non-contact manner, and the non-contact inspection module cooperates with the contact inspection module for determining a position of the circuit defect; and
a laser repair module having a laser head and a third driving-system, wherein the third driving-system drives the laser head to go to the position of the circuit defect and to repair the circuit defect.

2. The apparatus as claimed in claim 1, wherein the first driving-system includes:
a first vertical driving-unit for driving at least one contact probe to move in a vertical direction relative to the glass substrate;
a first horizontal driving-unit for driving at least one contact probe to move in a horizontal direction relative to the glass substrate; and
a front-and-back driving-unit for driving at least one contact probe to move forward and backward relative to the glass substrate.

3. The apparatus as claimed in claim 1, wherein the second driving-system includes:
a second vertical driving-unit for driving at least one non-contact sensor to move in a vertical direction relative to the glass substrate;
a second horizontal driving-unit for driving at least one non-contact sensor to move in a horizontal direction relative to the glass substrate; and
a first linear motor driving-unit having a motor main body and a first mover that connects with the second horizontal driving-unit.

4. The apparatus as claimed in claim 1, wherein the third driving-system includes:
a third horizontal driving-unit for driving the laser head to move in a horizontal direction relative to the glass substrate; and
a first linear motor driving-unit having a motor main body and a second mover that connects with the third horizontal driving-unit.

5. The apparatus as claimed in claim 1, wherein the non-contact sensor is in an electrostatic capacitory coupling type.

6. The apparatus as claimed in claim 2, wherein the first vertical driving-unit has a rotary motor, a screw, and a linear guide set.

7. The apparatus as claimed in claim 2, wherein the first horizontal driving-unit has a linear motor.

8. The apparatus as claimed in claim 2, wherein the front-and-back driving-unit has a linear motor.

9. The apparatus as claimed in claim 2, wherein the front-and-back driving-unit has a rotary motor, a screw, and a guide set.

10. The apparatus as claimed in claim 3, wherein the second vertical driving-unit has a cylinder or a linear actuator.

11. The apparatus as claimed in claim 3, wherein the second horizontal driving-unit has a linear actuator.

12. The apparatus as claimed in claim 4, wherein the third horizontal driving-unit has a linear motor.

13. The apparatus as claimed in claim 4, wherein the third horizontal driving-unit has a rotary motor, a screw, and a guide set.

14. A method for inspecting and repairing a circuit defect comprising:
providing an apparatus having a substrate-supporting platform, a contact inspection module having at least one contact probe and a first driving-system that drives at least one contact probe, a non-contact inspection module having at least one non-contact sensor and a second driving-system that drives at least one non-contact sensor, and a laser repair module having a laser head and a third driving-system that drives the laser head;
putting a glass substrate that waits for inspection on the substrate-supporting platform;
inspecting circuits on the glass substrate and determining the position of a circuit defect by moving at least one contact probe and at least one non-contact sensor;
moving the laser head to the circuit defect and repairing the circuit defect; and
moving the inspected and repaired glass substrate out of the substrate-supporting platform.

15. The method as claimed in claim 14, wherein the movement of at least one contact probe is carried out by a first driving-system, which has:
a first vertical driving-unit for driving at least one contact probe to move in a vertical direction relative to the glass substrate;
a first horizontal driving-unit for driving at least one contact probe to move in a horizontal direction relative to the glass substrate; and
a front-and-back driving-unit for driving at least one contact probe to move forward and backward relative to the glass substrate.

16. The method as claimed in claim 14, wherein the movement of at least one non-contact sensor is carried out by a second driving-system, which has:
a second vertical driving-unit for driving at least one non-contact sensor to move in a vertical direction relative to the glass substrate;
a second horizontal driving-unit for driving at least one non-contact sensor to move in a horizontal direction relative to the glass substrate; and
a first linear motor driving-unit having a motor main body and a first mover that connects with the second horizontal driving-unit.

17. The method as claimed in claim 14, wherein the movement of the laser head is carried out by a third driving-system, which has:
a third horizontal driving-unit for driving the laser head to move in a horizontal direction relative to the glass substrate; and
a first linear motor driving-unit having a motor main body and a second mover that connects with the third horizontal driving-unit.
